(19) United States
(12) Patent Application Publication
(10) Pub. No.: US 2024/0175583 A1
(43) Pub. Date: May 30, 2024

(54) PORTABLE HEATER

(71) Applicant: MILWAUKEE ELECTRIC TOOL CORPORATION, Brookfield, WI (US)

(72) Inventors: Nathan Beining, Milwaukee, WI (US); Srdjan Acimovic, Hales Corners, WI (US); Jon Pinske, Pewaukee, WI (US); Emily Siira, Waukesha, WI (US); Grace Widmeyer, Cincinnati, OH (US)

(21) Appl. No.: 18/551,232

(22) PCT Filed: Mar. 29, 2022
(86) PCT No.: PCT/US2022/022290

§ 371 Date: Sep. 19, 2023

Related U.S. Application Data
(60) Provisional application No. 63/167,928, filed on Mar. 30, 2021.

(51) Int. Cl. F24C 3/08; F24C 3/04; F24C 3/10; F24C 3/12

(52) U.S. Cl. CPC F24C 3/08; F24C 3/04; F24C 3/10; F24C 3/12

(57) ABSTRACT

A portable heater includes a housing defining a base portion and a radiant heating assembly positioned within the housing. The radiant heating assembly includes a connector configured to receive a fuel tank having a combustible fuel, an ignition assembly configured to ignite the combustible fuel, and a radiant heating surface configured to be heated by ignition of the combustible fuel. The radiant heating surface is configured to emit radiant energy to a surrounding environment. An air flow channel is formed in the housing defines an intake opening and an exhaust opening. The exhaust opening is positioned proximate the radiant heating surface. A fan is positioned within the air flow channel to induce an airflow through the air flow channel. The airflow exits the exhaust opening to disperse the radiant energy from the radiant heating surface to the surrounding environment.

### CROSS-REFERENCE TO RELATED APPLICATIONS

This application claims priority to U.S. Provisional Patent Application No. 63/167,928 filed on Mar. 30, 2021, the entire contents of which are incorporated herein by reference.

### FIELD OF THE INVENTION

The present invention relates to a portable heater, and more particularly to a portable heater having a radiant heating assembly.

### BACKGROUND OF THE INVENTION

There are various portable heaters known in the art for providing heat to a surrounding area. These portable heaters utilize various means known in the art to produce heat (e.g., via a radiant heating assembly, a combustion heating assembly, etc.) to heat the surrounding environment.

### SUMMARY OF THE INVENTION

The present invention provides, in one aspect, a portable heater including a housing defining a base portion and a radiant heating assembly positioned within the housing. The radiant heating assembly including a connector configured to receive a fuel tank having a combustible fuel, an ignition assembly configured to ignite the combustible fuel, and a radiant heating surface configured to be heated by ignition of the combustible fuel. The radiant heating surface configured to emit radiant energy to a surrounding environment. An air flow channel formed in the housing. The air flow channel defining an intake opening and an exhaust opening, the exhaust opening positioned proximate the radiant heating surface. A fan positioned within the air flow channel to induce an airflow through the air flow channel. The airflow exits the exhaust opening to disperse the radiant energy from the radiant heating surface to the surrounding environment.

The present invention provides, in another aspect, a portable heater including a housing defining a base portion, a heating assembly positioned within the housing, the heating assembly including a radiant heating surface configured to emit radiant energy to a surrounding environment, an air flow channel formed in the housing, the air flow channel defining an intake opening and an exhaust opening, the exhaust opening positioned proximate the radiant heating surface, and a fan positioned within the air flow channel to induce an airflow through the air flow channel. The airflow exits the exhaust opening to disperse the radiant energy from the radiant heating surface to the surrounding environment.

The present invention provides, in another aspect, a portable heater including a housing, and a radiant heating assembly positioned within the housing. The radiant heating assembly including a connector configured to receive a fuel tank having a combustible fuel, an ignition assembly configured to ignite the combustible fuel, and a radiant heating surface configured to be heated by ignition of the combustible fuel, the radiant heating surface configured to emit radiant energy to a surrounding environment. An air flow channel formed in the housing, the air flow channel defining an intake opening and an exhaust opening. A fan disposed within the air flow channel and operable to induce an airflow through the air flow channel. The connector and the fuel tank are positioned between the fan and the intake opening, and the airflow induced by fan enters the air flow channel from an external environment, moves over the fuel tank to reduce heat surrounding the fuel tank, and exits the air flow channel to disperse the radiant energy from the radiant heating surface to the external environment.

Other features and aspects of the invention will become apparent by consideration of the following detailed description and accompanying drawings.

### BRIEF DESCRIPTION OF THE DRAWINGS

FIG. 1 is a perspective view of a portable heater in accordance with an embodiment of the invention.

FIG. 2 is a rear view of the portable heater of FIG. 1.

FIG. 3 is a side, perspective view of the portable heater of FIG. 1, illustrating a door in an open position for installation of a fuel tank.

FIG. 4 is top view of a user interface of the portable heater of FIG. 1.

FIG. 5 is a side view of the portable heater of FIG. 1 with a housing of the heater being transparent to illustrate the internal components of the heater.

FIG. 6 is a top view of the portable heater of FIG. 1 with the housing of the heater being transparent to illustrate the internal components of the heater.

FIG. 7 is a side view of the portable heater of FIG. 1, illustrating an air flow path formed in the heater to disperse heated air to the surrounding environment.

FIG. 8 is a top view of the portable heater of FIG. 1, illustrating the air flow path formed in the heater to disperse heated air to the surrounding environment.

FIG. 9 is a perspective view of a portable heater in accordance with another embodiment of the invention.

FIG. 10 is a rear perspective view of the portable heater of FIG. 9.

FIG. 11 is a rear perspective view of the portable heater of FIG. 9, illustrating a door in an open position for installation of a fuel tank.

FIG. 12 is top view of a user interface of the portable heater of FIG. 9.

FIG. 13 is a front perspective view of the portable heater of FIG. 9, illustrating a pilot light.

FIG. 14 is a side view of the portable heater of FIG. 9, illustrating an air flow path formed in the heater to disperse heated air to the surrounding environment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

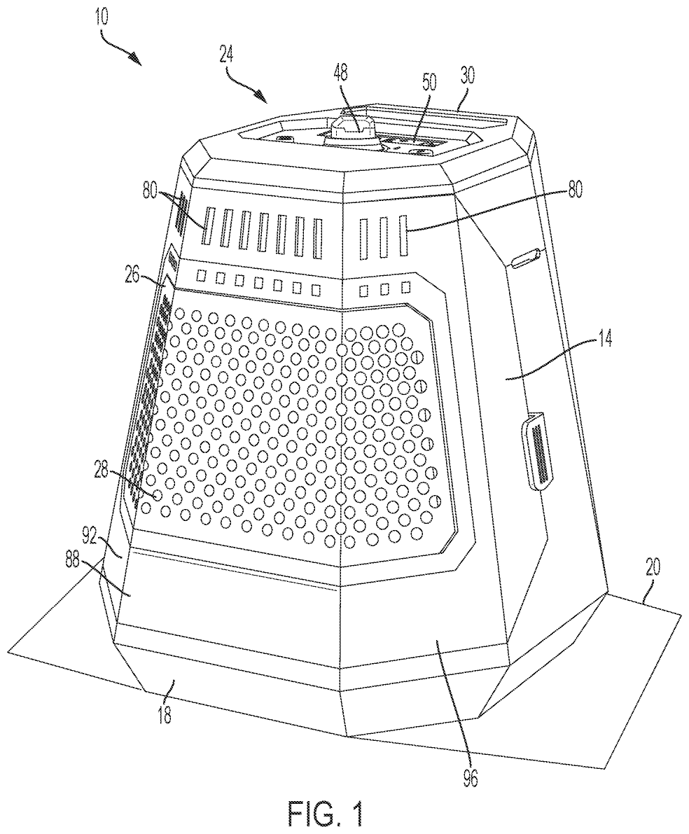

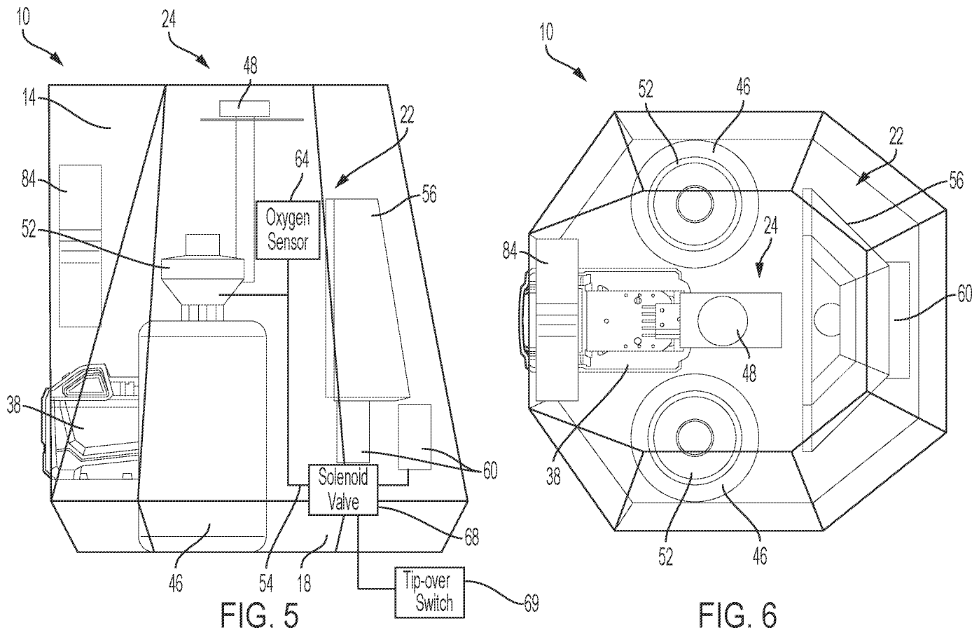

FIG. 1 illustrates a portable radiant heater 10 for introducing infrared radiant heat to a surrounding environment. The portable radiant heater 10 includes a housing 14 defining a base portion 18 that supports the heater 10 relative to a surface 20, a heating assembly 22 (FIGS. 5 and 6) enclosed within the housing 14, and a user interface 24 located on a top portion of the housing 14 to selectively activate the heating assembly 22. In the illustrated embodiment, the housing 14 has an octagonal geometry where the base portion 18 has a larger width than the top portion of the heater 10. In other words, the housing 14 tapers inward as the housing 14 extends upwards from the base portion 18. In other embodiments, the housing may have an alternative geometry (e.g., circular, rectangular, etc.).

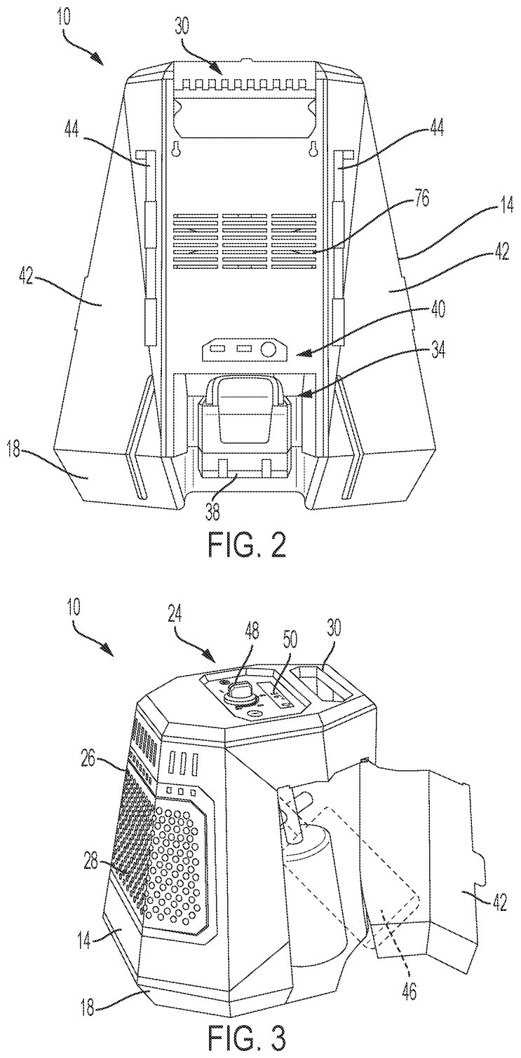

The heater 10 may include a grate 26 that protects the heating assembly 22 within the housing 14. A plurality of apertures 28 may be formed in the grate 26 to allow the infrared radiant energy from the heating assembly 22 to escape from the housing 14 through the apertures 28. A handle 30 is formed on a rear portion of the top portion of the housing 14 (FIG. 2). In the illustrated embodiment, the handle 30 is formed as a recess in the housing 14, which the user may grasp to transport the heater 10. In other embodiments, the handle may have an alternative construction (e.g., be pivotably coupled to the housing 14, etc.).

Now with reference to FIG. 2, a battery receptacle 34 selectively receives a battery pack 38 that powers the user interface 24 and an ignition assembly 60 (FIGS. 5 and 6) of the heater 10, as described in more detail below. The battery pack 38 may be interchangeably coupled with the heater 10 or another power tool (e.g., a drill, a saw, etc.). The battery pack 38 may be a 12-volt power tool battery pack 38 that include three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. In some embodiments, the heater 10 may further include one or more back-up battery packs (e.g., 12 V battery packs, AAA battery packs, etc.). The heater 10 further includes a USB door 40 that selectively encloses a USB port. The USB port may receive a USB cord that can be used for charging an external device (e.g., a mobile device) using the battery pack 38.

Now with reference to FIGS. 2 and 3, each side of the housing 14 includes a door 42 that allows the operator to access an interior space of the heater 10. In the illustrated embodiment, each door 42 pivots about a pivot joint 44 (FIG. 2). The door 42 provides access to the interior space of the heater 10 so a user is able to install a fuel tank 46 (e.g., an 8 oz propane tank) having a combustible fuel in the heater 10. In other embodiments, the door 42 may have an alternative construction (e.g., sliding connection, etc.).

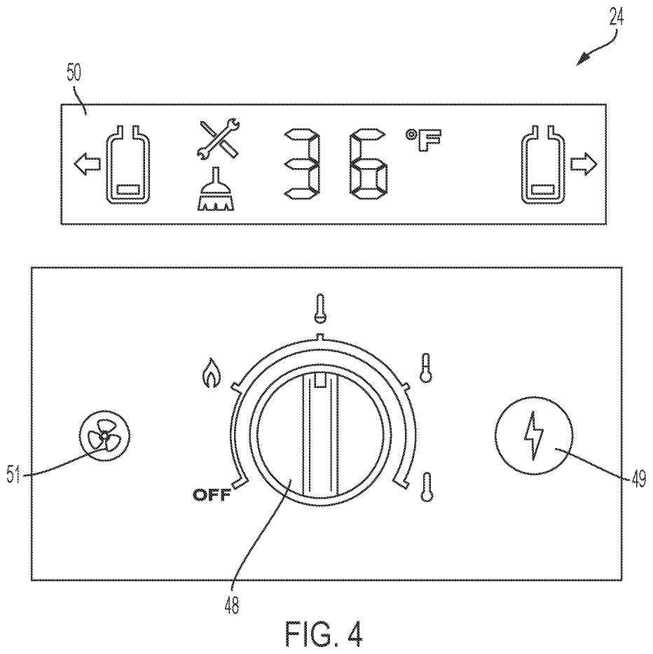

Now with reference to FIG. 4, the user interface 24 includes a rotatable dial 48 for controlling the heating assembly 22 and an LCD display 50. The dial 48 may control the amount of combustible fuel that is provided to the heating assembly 22 and may be moved between an OFF state, an ignition state, and an ON state. The LCD display 50 may display information to the user such as the state of the heater 10 (e.g., on, off, or ignition state), an error message (e.g., fuel empty, cleaning required, etc.), an external temperature of the surrounding environment, or the like. In some embodiments, the user interface 24 may include an ignition button 49 that selectively activates the ignition assembly 60 and a fan button 51 that selectively activates a fan 84 (FIGS. 5 and 6), which is described in more detail below:

Now with reference to FIGS. 5 and 6, the heating assembly 22 includes two connectors 52 that respectively connect to the fuel tanks 46, a fuel line 54 coupled to each connector 52, a radiant heating surface 56, and an ignition assembly 60. In the illustrated embodiment, the connectors 52 include a regulator that limits the volumetric flow rate of fuel from the fuel tank 46. The ignition assembly 60 is controlled by the user interface 24 and may be selectively activated to ignite the combustible fuel to heat the radiant heating surface 56. The ignition assembly 60 may include an igniter and a pilot light. In the illustrated embodiment, the dial 48 may be moved to the ignition state, which causes an extrusion on the dial 48 to compress an ignition switch. In response to the ignition switch being compressed, the igniter continuously provides a spark to ignite the combustible fuel. Once the fuel is ignited, the dial 48 may be moved to the ON state so the combustible fuel heats the radiant heating surface 56. The radiant heating surface 56 may be formed of materials such as chromel, ceramic, a Fecralloy metal fabric, or the like. In the illustrated embodiment, the radiant heating surface 56 is formed of Fecralloy metal fabric.

In some embodiments, the heater 10 may include an oxygen sensor 64 and a solenoid valve 68 in communication with the fuel line 54. The oxygen sensor 64 may be configured as a thermocouple that is exposed to the pilot light of the ignition assembly 60 and that is operable to detect that the flame emitted by the ignition assembly 60 has been extinguished. The solenoid valve 68 is responsive to input from the oxygen sensor 64 to selectively restrict fuel to the ignition assembly 60 in response to the oxygen sensor 64 detecting that the flame emitted by the ignition assembly 60 is extinguished. In some embodiments, the heater 10 may further include a tip-over switch 69 in communication with the solenoid valve 68, which sends a signal to the solenoid valve 68 and restricts fuel to the ignition assembly 60 when the heater 10 is tipped over.

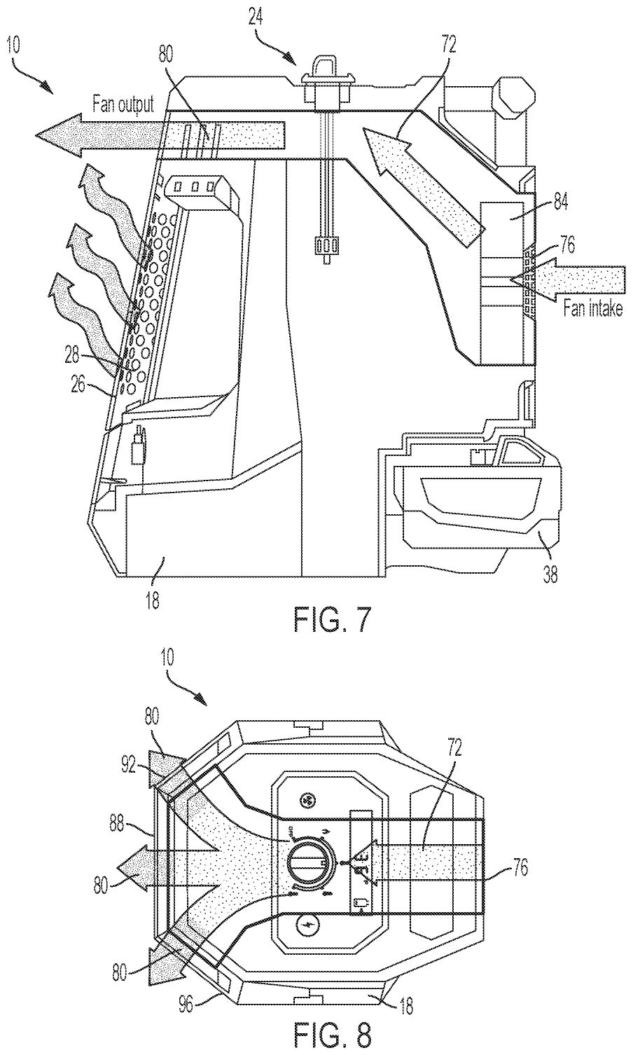

Now with reference to FIGS. 7 and 8, an air flow channel 72 is formed in the housing 14 and extends between a rear portion and a front portion of the housing 14. The air flow channel 72 defines an intake opening 76 in the rear portion of the housing 14 and an exhaust opening 80 in the front portion of the housing 14 proximate the radiant heating surface 56. The intake and/or exhaust openings 76, 80 may be formed as a series of slits in the housing 14 as shown in FIGS. 1 and 2. In the illustrated embodiment, the exhaust opening 80 of the air flow channel 72 is positioned above the radiant heating surface 56 of the heating assembly 22 (FIG. 6). A fan 84 is positioned within the air flow channel 72 proximate the intake opening 76. Activation of the fan 84 (e.g., via the fan button 51 shown in FIG. 4) induces an airflow through the air flow channel 72 and out of the exhaust opening 80 to disperse the infrared radiant energy from the radiant heating surface 56 to the surrounding environment.

Now with reference to FIGS. 1 and 8, the exhaust opening 80 includes a plurality of openings 80 that are angled relative to each other to disperse the air moving through the air flow channel 72 in multiple directions at the front of the housing 14. In the illustrated embodiment, the exhaust opening 80 includes a first plurality of openings 80 formed on a front face 88 of the heater 10, a second plurality of openings 80 formed on a first angled surface 92, and a third plurality of openings 80 formed on a second angled surface 96. Therefore, the configuration of the exhaust opening 80 promotes dispersion of the air flow and the emitted radiant heat at the front of the housing 14.

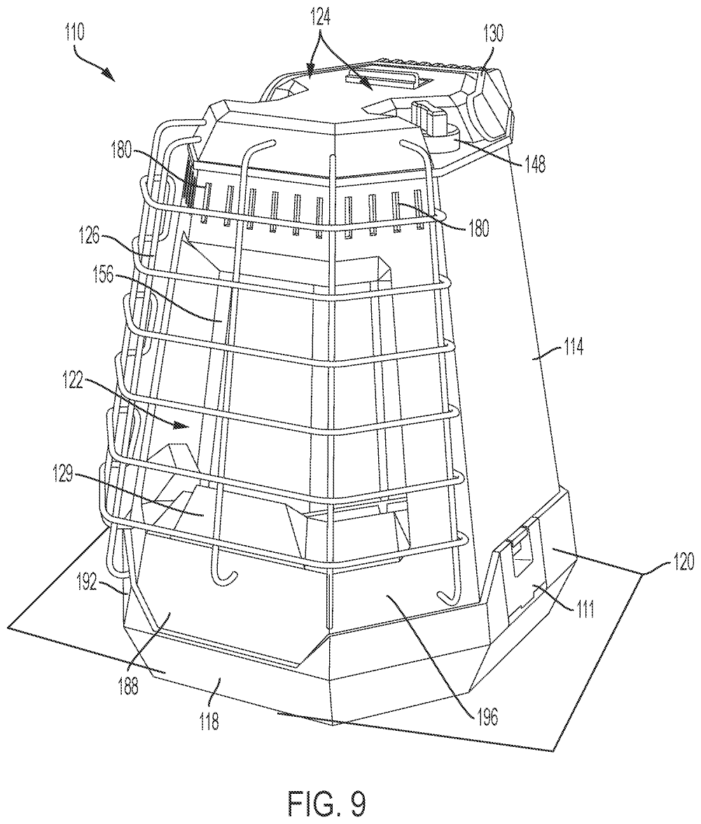

FIGS. 9-14 illustrate a portable radiant heater 110 according to another embodiment of the invention. The portable radiant heater 110 is like the portable heater shown in FIGS. 1-8 and described above. Therefore, like features for the portable radiant heater 110 are identified with like reference numerals plus “100”, and only the differences between the two will be discussed.

The portable radiant heater 110 includes a housing 114 defining a base portion 118 that supports the heater 110 relative to a surface 120, a heating assembly 122 supported within the housing 114, and a user interface 124 located on a top portion of the housing 14 to selectively activate the heating assembly 122. The heater 110 may include a wire grate 126 that protects the heating assembly 122 within the housing 114. A handle 130 is pivotably coupled a rear portion of the top portion of the housing 114 (FIG. 11).

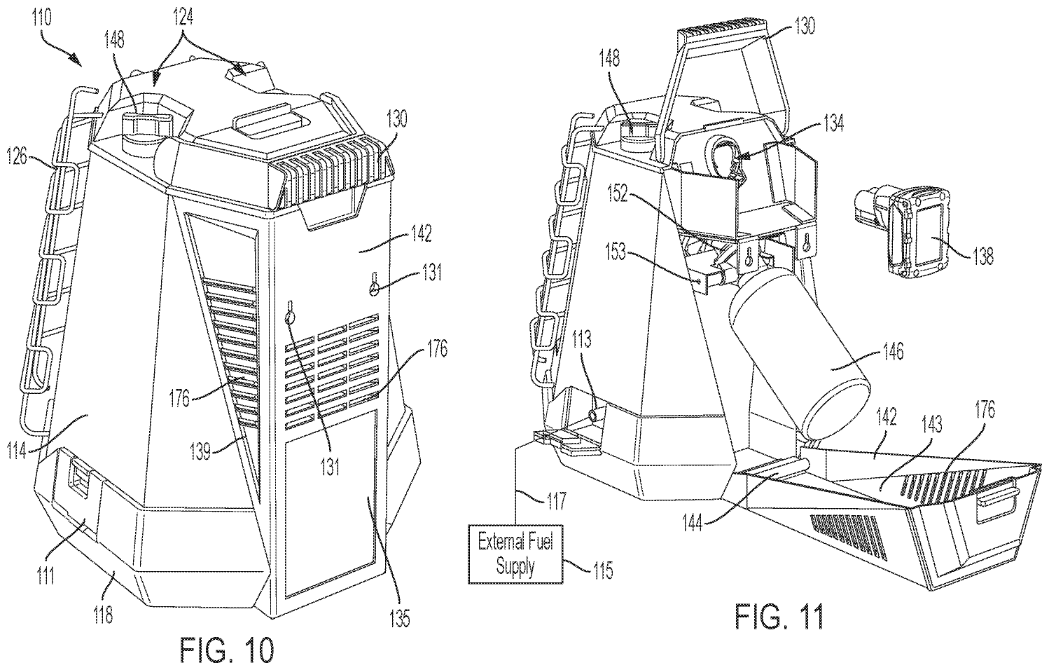

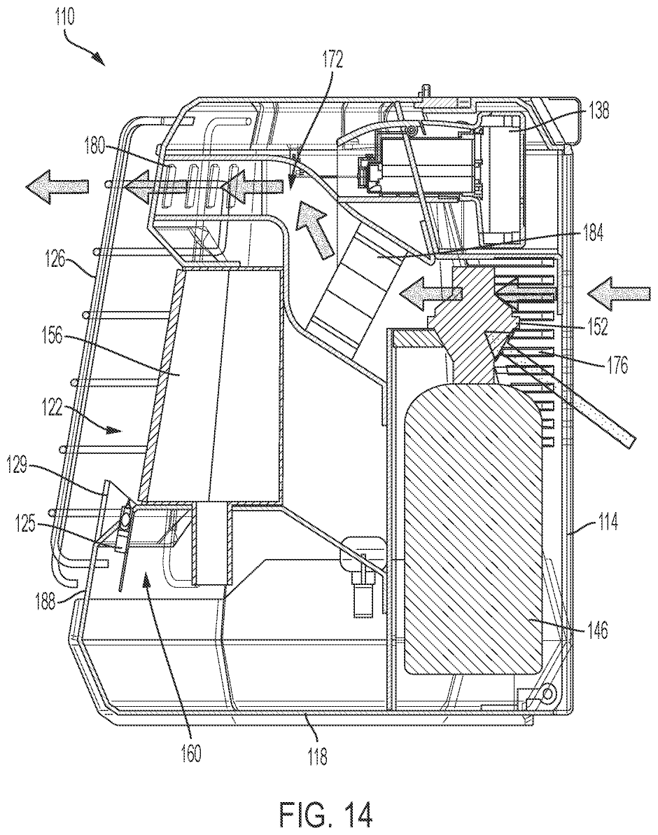

Now with reference to FIGS. 10 and 11, a rear portion of the housing 114 includes a door 142 that allows the operator to access an interior space of the heater 10. In the illustrated embodiment, the door 142 pivots about a pivot joint 144 (FIG. 11) positioned adjacent the base portion 118. The door 142 provides access to the interior space of the heater 110 so a user is able to access a connector 152 and a battery receptacle 134. In the illustrated embodiment, the connector 152 pivots about a pivot joint 153 so the user can install a fuel tank 146 (e.g., an 8 oz propane tank) having a combustible fuel in the heater 110. The battery receptacle 134 is positioned above the connector 152 proximate a top portion of the heater 110 and is sized to receive a battery pack 138 that powers the user interface 124 and an ignition assembly 160 (FIGS. 13 and 14) of the heater 10, as described in more detail below. The position of the battery receptacle 134 allows the battery pack 138 to be fully enclosed within the housing 114 when the door 142 is closed (FIG. 10) to protect the battery pack 138.

With continued reference to FIGS. 10 and 11, the heater 10 may include a compartment 111 positioned adjacent the base portion 118 (e.g., on a lower right side of the housing 114) that houses a second connector 113. The second connector 113 may be connected to an external fuel supply 115 (e.g., a 20 lb propane tank) via an adapter 117.

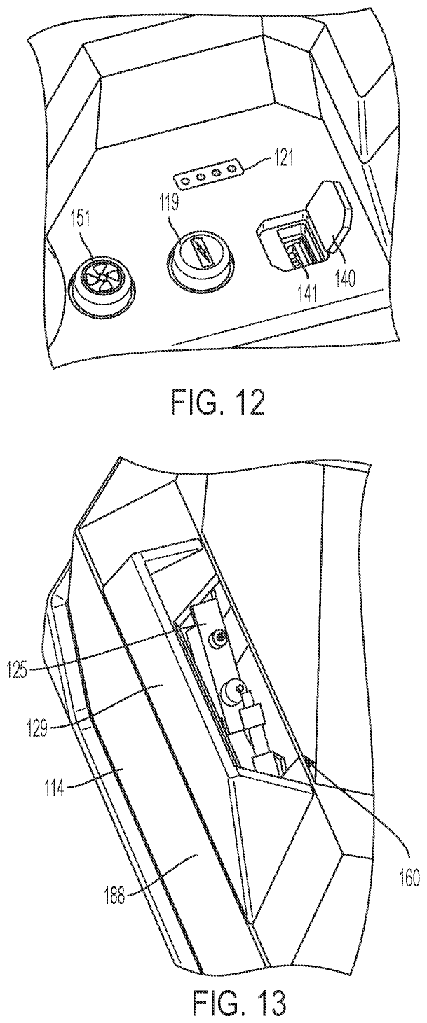

Now with reference to FIGS. 10 and 12, the user interface 124 includes a rotatable dial 148 (FIG. 10) for controlling a regulator valve in the heating assembly 122, thus controlling the temperature of the heating assembly 122. The user interface 124 also includes a USB door 140 (FIG. 12) that selectively encloses a USB port 141, a charging button 119 for selectively activating charging of an external device (e.g., a mobile device) connected to the USB port 141, a fan button 151 that selectively activates a fan 184 (FIG. 14), and an LED gauge 121 to display the amount of electrical power remaining in the battery pack 138. In the illustrated embodiment, the user interface 124 is recessed on the top portion of the heater 110 and the rotatable dial 148 is positioned on an opposing side of the heater 110 from the remaining components of the user interface 124.

Now with reference to FIGS. 13 and 14, the ignition assembly 160 includes a pilot light 125 that is positioned adjacent a radiant heating surface 156 (FIG. 14) of the heating assembly 122. The pilot light 125 is positioned behind a shield 129 that extends from a front face 188 of the heater 110. In the illustrated embodiment, the shield 129 is centered on the radiant heating surface 156 and prevents wind from affecting the pilot light 125.

With reference to FIG. 14, an air flow channel 172 is formed in the housing 114 and extends between a rear portion and a front portion of the housing 114. The air flow channel 172 defines an intake opening 176 in the rear portion of the housing 114 and an exhaust opening 180 in the front portion of the housing 114 proximate the radiant heating surface 156. A fan 184 is positioned within the air flow channel 172 proximate the intake opening 176. In the illustrated embodiment, the connector 152 and the fuel tank 146 are positioned between the fan 184 and the intake opening 176. Activation of the fan 184 (e.g., via the fan button 151 shown in FIG. 12) induces an airflow over the fuel tank 146 and the connector 152, through the air flow channel 172, and out of the exhaust opening 180. The airflow moving over the fuel tank 146 reduces heat surrounding the fuel tank 146 and the airflow that exits the exhaust opening 180 disperses the infrared radiant energy from the radiant heating surface 156 to the surrounding environment.

Now with reference to FIGS. 10, 11, and 14, the door 142 may include wall hanging attachments 131 (FIG. 10) formed as apertures that are sized to receive a screw. In the illustrated embodiment, the intake opening 176 includes a first plurality of openings 176 formed on a rear face 135 of the heater 110, a second plurality of openings 176 formed on a first angled rear surface 139 (FIG. 10), and a third plurality of openings 176 formed on a second angled rear surface 143 (FIG. 11). Therefore, the configuration of the intake opening 180 promotes the intake of air into the air flow channel 172. For example, when the heater 110 is attached to a wall via the wall hanging attachments 131, the first plurality of openings 176 on the rear face 135 of the heater 110 may be covered, but air may still enter the heater 110 through the second and third plurality of openings 176 on the first and second angled rear surfaces 139, 143.

Although the invention has been described in detail with reference to certain preferred embodiments, variations and modifications exist within the scope and spirit of one or more independent aspects of the invention as described.

Various features of the invention are set forth in the following claims.

What is claimed is:

1. A portable heater comprising:
a housing defining a base portion;
a radiant heating assembly positioned within the housing, the radiant heating assembly including
a connector configured to receive a fuel tank having a combustible fuel,
an ignition assembly configured to ignite the combustible fuel, and
a radiant heating surface configured to be heated by ignition of the combustible fuel, the radiant heating surface configured to emit radiant energy to a surrounding environment:
an air flow channel formed in the housing, the air flow channel defining an intake opening and an exhaust opening, the exhaust opening positioned proximate the radiant heating surface; and
a fan positioned within the air flow channel to induce an airflow through the air flow channel,
wherein the airflow exits the exhaust opening to disperse the radiant energy from the radiant heating surface to the surrounding environment.

2. The portable heater of claim 1, wherein the connector and the fuel tank are positioned between the fan and the intake opening, and wherein the fan is configured to induce airflow over the connector and the fuel tank to reduce heat surrounding the fuel tank.

3. The portable heater of claim 1, further comprising a battery receptacle configured to receive a battery to power the ignition assembly.

4. The portable heater of claim 3, further comprising a USB port configured to charge an external device via power from the battery.

5. The portable heater of claim 1, further comprising a user interface.

6. The portable heater of claim 5, wherein the user interface includes a rotatable dial configured to control an amount of combustible fuel provided to the radiant heating assembly, and wherein the rotatable dial is movable between an OFF state, an ignition state, and an ON state.

7. The portable heater of claim 5, wherein the user interface includes a display configured to display information about one or more of a state of the portable heater, an error message, or an external temperature of the surrounding environment.

8. The portable heater of claim 5, wherein the user interface includes a fan button configured to selectively activate the fan.

9. The portable heater of claim 1, wherein the radiant heating assembly further includes a second connector configured to connect an external fuel supply to the radiant heating assembly.

10. The portable heater of claim 1, further comprising a pivotable door configured to allow a user to access the connector for installation and replacement of the fuel tank.

11. The portable heater of claim 1, further comprising
an oxygen sensor configured to detect whether a flame emitted by the ignition assembly has been extinguished, and
a valve configured to selectively restrict fuel to the ignition assembly in response to the oxygen sensor detecting that the flame emitted by the ignition assembly has been extinguished.

12. The portable heater of claim 11, further comprising a tip-over switch in communication with the valve, wherein the tip-over switch is configured to send a signal to the valve to restrict fuel to the ignition assembly when the heater is tipped over.

13. A portable heater comprising:
a housing defining a base portion;
a heating assembly positioned within the housing, the heating assembly including a radiant heating surface configured to emit radiant energy to a surrounding environment;
an air flow channel formed in the housing, the air flow channel defining an intake opening and an exhaust opening, the exhaust opening positioned proximate the radiant heating surface; and
a fan positioned within the air flow channel to induce an airflow through the air flow channel,
wherein the airflow exits the exhaust opening to disperse the radiant energy from the radiant heating surface to the surrounding environment.

14. The portable heater of claim 13, wherein the intake opening is defined by a plurality of openings.

15. The portable heater of claim 14, wherein the plurality of openings includes a first plurality of openings formed on a rear face of the heater, a second plurality of openings formed on a first angled surface of the heater, and a third plurality of openings formed on a second angled surface of the heater.

16. The portable heater of claim 13, wherein the exhaust opening of the air flow channel is positioned above the radiant heating surface of the heating assembly.

17. The portable heater of claim 13, wherein the exhaust opening is defined by a plurality of openings that are angled relative to each other to disperse the air moving through the air flow channel in multiple directions at the front of the housing.

18. The portable heater of claim 17, wherein the plurality of openings includes a first plurality of openings formed on a front face of the heater, a second plurality of openings formed on a first angled surface of the heater, and a third plurality of openings formed on a second angled surface of the heater.

19. A portable heater comprising:
a housing;
a radiant heating assembly positioned within the housing, the radiant heating assembly including
a connector configured to receive a fuel tank having a combustible fuel,
an ignition assembly configured to ignite the combustible fuel, and
a radiant heating surface configured to be heated by ignition of the combustible fuel, the radiant heating surface configured to emit radiant energy to a surrounding environment;
an air flow channel formed in the housing, the air flow channel defining an intake opening and an exhaust opening;
a fan disposed within the air flow channel and operable to induce an airflow through the air flow channel,
wherein the connector and the fuel tank are positioned between the fan and the intake opening, and
wherein the airflow induced by fan enters the air flow channel from an external environment, moves over the fuel tank to reduce heat surrounding the fuel tank, and exits the air flow channel to disperse the radiant energy from the radiant heating surface to the external environment.

20. The portable heater of claim 19, wherein the exhaust opening of the air flow channel is positioned above the radiant heating surface of the radiant heating assembly.
